(19) United States
(12) Patent Application Publication
(10) Pub. No.: US 2012/0227929 A1
(43) Pub. Date: Sep. 13, 2012

(54) DETECTOR HEATING AND/OR COOLING

(75) Inventors: Darren Michael Rose, Christchurch (GB); Roger Thomas Hurrey, Wimborne (GB)

(73) Assignee: GROVELEY DETECTION LIMITED

(21) Appl. No.: 13/509,943

(22) PCT Filed: Nov. 16, 2010
(86) PCT No.: PCT/GB10/51907

§ 371 Date: May 15, 2012

(30) Foreign Application Priority Data
Nov. 16, 2009 (GB) 0919959.7

(51) Int. Cl. F28F 27/00; F28D 15/02; G05D 23/19

(52) U.S. Cl. 165/11.1

(57) ABSTRACT

A detector (100), such as a gas or flame detector, having a housing which provides protection against explosion and/or ingress, which detector comprises at least one temperature sensor, a heating and/or cooling element (14) and at least one heat pipe (7, 8, 9) connected between a first and a second part of the detector, the arrangement being such that, in use, said temperature sensor provides an output signal indicating a temperature of a part of said at least one heat pipe (7, 8, 9), and which output signal is used to control said heating and/or cooling element (14) to warm or cool said at least one heat pipe, whereby the temperature at each of said first and second parts of the detector may be maintained substantially the same.

### FIELD OF THE INVENTION

The present invention relates to a detector, such as a gas, smoke or flame detector, to a heating apparatus for use in such a detector, to a method of adapting a detector with such a heating apparatus, and to a method of surveying an area for emission of gas, smoke or flame.

### BACKGROUND OF THE INVENTION

Many industrial operations, such as well drilling, oil production, oil refining and industrial gas production, utilise piping to move a wide variety of high-pressure fluids such as gas and liquids. The pipes move such fluids for operating and controlling industrial processes amongst other things. Frequently the fluids that are piped arc potentially explosive and the piping requires careful monitoring for leaks, smoke and/or flames—both must be identified quickly to enable the appropriate remedial action to be taken. Areas and spaces around such equipment can be known by different names such as “Hazardous Locations”, “Hazardous Areas” “Explosive Atmospheres”; these include, but are not limited to, areas where flammable liquids, vapours, gases or combustible dusts are likely to occur in quantities sufficient to cause a fire or explosion. Generally such areas have become known “Ex” areas in the art, and equipment used in those areas as “Ex equipment”.

Three main kinds of detector are mounted in situ in such environments for that purpose: gas detectors, smoke detectors and flame detectors. Gas detectors include ultrasonic detectors, infra-red detectors and chemical detectors. Flame detectors include infra-red and optical detectors, and smoke detectors include photoelectric (optical), ionisation and aspirating. Usually detectors for use in industrial operations have to be provided with an enclosure that meets one or more national or international standard for resistance to explosion and/or ingress, such as the IEC Ex Certification Scheme for Explosive Atmospheres (see www.iccex.com). Such standards are intended to help manufacturers build detectors that are resistant to ingress of potentially explosive gases and, if there is such ingress, to resist any explosion leaving the interior of the detector.

Most such detectors have a supplier-fixed operating external temperature range according to the constraints imposed by the electronic components contained within a main enclosure compartment. Typical operating ranges are between −40° C. and −20° C. at the lower end, and between 35° C. and 65° C. for upper end. The size of the temperature range is dependent on the quality of the electronic components, specified using (amongst other criteria) functionality, reliability and cost. Cost is often a major factor and cheaper components usually have a smaller operating temperature range. When exposed to temperatures outside the operating range, such components may fail to act within the original design parameters; this may result in drift of the detector output signal or, in the worst case, complete failure of the detector.

Previously the operating temperature ranges mentioned above have not been a particular problem as most industrial environments in which the detectors were used fell within range, and the limited number of applications which required an extended temperature range would be treated as special cases. In the latter circumstance, a detector would be fitted with additional devices including insulation, trace heating or other heating elements to warm the whole detector for a cold application, and heat-sinks or heat barriers between detector and heat source for a warm application.

These additional devices do work to some extent, but each particular application must be studied and calculations performed to determine the heating or cooling values required, resulting in extra manufacturing time and cost. These custom-built detectors are also very inefficient: typically the temperature on the outside of the detector is monitored, and the whole unit heated or cooled in response. Since the additional heating/cooling devices are retro-fitted to standard detectors, a separate power source and temperature control is used to power the devices and the former are usually not part of detector's fail safe system. This is undesirable as the detector's control system needs two inputs: one for the heating system and one for the detector. Maintenance of custom-built detectors can also be difficult as the detector is obscured by the heating or cooling mechanism.

Other problems can occur at less extreme temperatures (i.e. within the operating range) with optical (e.g. camera), ultrasonic and chemical detectors. Such detectors need to be open to the environment they are monitoring and freezing of sensing paths or hot-spot build up may occur which can alter detector response, cause detector fault alarms or damage internal components if left unchecked.

Some existing optical detectors have a respective heating element on a sensor window and a return mirror to inhibit icing. However the heating elements are controlled in response to internal enclosure conditions as indicated by temperature sensors. The temperature sensors rely on heat convection around the inside of the enclosure which is inefficient and can be inaccurate in certain conditions. Any source of heat outside of the enclosure (e.g. the heating element associated with the return mirror) is also isolated from the main enclosure temperature sensor since heating element is outside the ingress/explosion protection wall. In these detectors, a power cable usually feeds an encapsulated heating element behind the mirror, which requires a separate temperature sensor or remains unregulated.

Other existing detectors comprise heating elements built into the enclosure of the detector and which rely upon convection. This usually results in a hot area around each heating element, potentially leaving cold spots in other areas. All heating systems which rely upon convection require multiple temperature sensors to accurately monitor the temperature of the detector, adding extra cost and processing power, and relying heavily on the designer of the detector to reduce temperature difference between parts of the detector.

Traditional industrial environments have temperature ranges within the range −40° C. to +40° C. Many new industrial environments have wider temperature ranges where temperatures do fall below −40° C. (for example in Alaska) and rise above +40° C.; the latter circumstance can arise inside the housing of a gas turbine for example, where the temperature can be a steady +85° C. This has resulted in a need for detectors that have a working temperature range that is extended, e.g. to temperatures between about −50° C. and +85° C.

Advances in electronics in recent years have extended component operating values, which enable certain detectors to be redesigned for harsh environments (albeit at extra cost in components). However, we have realised that this increased operating temperature range also requires a redesign of the enclosure to accommodate the new thermal expansion and contraction rates. This necessitates an increase in protection paths lengths resulting in a larger enclosure, and thereby an increase in manufacturing costs.

Many detectors are required to be constructed to provide ingress protection and in some cases explosion protection; it would be beneficial to be able to accurately control the overall temperature of the enclosure to avoid excessive expansion and contraction.

### SUMMARY OF THE INVENTION

According to at least some embodiments of the invention there is provided a detector, such as a gas, smoke or flame detector, comprising at least one temperature sensor, a heating and/or cooling clement and at least one heat pipe connected between a first and a second part of the detector, the arrangement being such that, in use, said temperature sensor provides an output signal indicating a temperature of a part of said at least one heat pipe, and which output signal is used to control said heating and/or cooling element to warm or cool said at least one heat pipe, whereby the temperature at each of said first and second parts of the detector may be maintained substantially the same. In certain aspects the detector is of the kind intended for use in harsh and/or hazardous environments (such as underwater, in explosive atmospheres, and/or in a designated Ex area), and/or subject to extreme temperatures (for example −50° C. to +85° C.). It may be resistant to ingress of gas and/or able to contain an explosion within the detector. For example the detector may comprise a housing or enclosure which complies with one or more explosion and/or ingress protection standard (such as the IEC Ex Certification Scheme for Explosive Atmospheres, and/or any other standard in existence at the filing date hereof, or any such future standard).

In other aspects the detector may comprise a housing or enclosure which complies with current or future versions of EN 60079-0 (“Electrical Equipment for Explosive Gas Atmospheres”), and/or any other current or future equivalent national or international standard. In certain aspects the detector may be of the “II non-mining” class, and preferably is designed for use in explosive gas atmospheres. Furthermore, the detector may be of the Ex d and Ex i category, so that the detector is rated to contain an explosion and is intrinsically safe respectively. “Intrinsically safe” may mean that the detector is designed so that its power consumption is below level a level that is capable of causing an explosion.

In some aspects the heating element may comprise a resistor and/or transistor for example. The cooling clement may comprise a nozzle through which compressed air may be blown onto the at least one heat pipe (and/or onto another member in thermal contact therewith) for example.

In certain aspects, the at least one heat pipe is of the type in which evaporative cooling is employed to transfer thermal energy from one point on the heat pipe to another point on the heat pipe by the evaporation and condensation of a working fluid or coolant. To that end the at least one heat pipe may be in the form of a sealed pipe or tube comprising a material with high thermal conductivity, such as copper or aluminium. Other cross-section shaped pipes are possible, and the invention is not limited to the use of circular cross-section heat pipes.

In some embodiments of the invention there is provided an apparatus for heating more than one part of a detector enclosure using a single temperature controller and a heat pipe. The heat pipe is positioned between two parts of the detector and the single temperature controller controls the temperature of any point of the heat pipe (either directly or indirectly via an intermediate thermally conductive material for example). In this way, different parts of the detector can be maintained at substantially the same temperature using the single temperature controller, and thermal expansion and contraction of the enclosure can be reduced.

In other embodiments of the invention there is provided an apparatus for heating a part of a detector outside an enclosure ingress/explosion protection wall using single temperature controller within that enclosure.

In some embodiments of the invention transfer of heat is achieved using heat pipes. This allows efficient transfer which can be passed through the ingress/explosive protection wall whilst allowing monitoring of temperature at both ends within close tolerances.

The temperature at multiple points (depending on the number of heat pipes used in the detector) inside and/or outside of the enclosure is controllable by connecting the heat pipes together (at any point) and applying heat (or cooling) and measuring the temperature of material connecting the heat pipes together (or indeed any part of one of the heat pipes) as the temperature of the material will be very nearly the same as the temperature at the end of the heat-pipe. This permits the temperature of multiple parts of the detector to be controlled using only a single temperature controller if desired. In certain aspects the connecting material is in the form of a plate to which the heat pipes are bonded.

The power applied to the heating elements on the connecting material can be varied in response to the measured temperature so that a predetermined temperature (5° C. for example) can be maintained. This allows efficient use of power irrespective of the external environmental temperature.

The temperature inside the detector enclosure may be maintained using convection from the heating or cooling elements and the connecting material (or heat plate) whilst the temperature of other parts is maintained using one or more heat pipe and conduction.

The detector may further comprise a heating element plate or member in thermal contact with said at least one heat pipe, the arrangement being such that, in use, the temperature of said heating element plate is monitored by said temperature sensor and said heating clement plate is heated or cooled by said heating and/or cooling element to control the temperature of said at least one heat pipe.

Conveniently, the heating clement plate comprises a metal plate of approximately circular shape, although a plate construction and that shape are not essential. The term ‘heating’ clement plate is used purely for convenience; the heating element plate can also be cooled to provide a cooling function in the detector.

In certain aspects the temperature sensor is single temperature sensor arranged to monitor the temperature of said heating element plate, whereby the temperature of multiple parts of said detector may be controlled using said single temperature sensor. In other embodiments the single temperature may be positioned to measure (directly or indirectly) the temperature of any point of the at least one heat pipe rather than the heating element plate.

In some embodiments the detector further comprises a plurality of heat pipes and wherein said heating element plate is in thermal contact with at least two of said plurality of heat pipes. In this way the temperature of multiple parts of the detector may be controlled by heating or cooling just the heating element plate.

In certain aspects the detector comprises a housing or enclosure which provides protection against explosion and/or ingress, and wherein said housing comprises a main body holding the majority of the components of the detector (or which main body comprises a central enclosure part of the detector, around which individual detector heads are mounted), and wherein said first part of the detector is within said main body and said second part of the detector is external of said main body. For example the second part may still be within a firewall part of the enclosure, but not actually within a main body of the enclosure. Alternatively, and in any embodiment described herein, two heat pipes may be used to pass heat across a wall of the main body of the housing: a first heat pipe within the main body of the housing, one end of which is in thermal contact with an inner surface of a heat transfer element in the wall of the housing, and a second heat pipe external of said main body, one end of which is in thermal contact with an outer surface of the heat transfer element, whereby heat may be transferred in either direction across the wall of the housing. The heat transfer element may be a thermally conductive plug secured by mechanical means such as a thread, or with thermally insulated epoxy resin if greater conductivity is required.

Arrangements as above permit the interior of the main body to be heated or cooled as required.

In some embodiments the detector may comprise a first heat plate mounted within said detector and in thermal contact with said at least one heat pipe, wherein in use, said first heat plate is warmed or cooled by said at least one heat pipe such that said first heat plate warms or cools an internal space within said detector. In this way, internal electronic components may be warmed or cooled as required.

In other embodiments the detector further comprises a second heat plate in thermal contact with said at least one heat pipe, which second heat plate is remote from said heating and/or cooling clement.

The second heat plate may be in thermal contact with a sensor housing on an external surface of said detector. For example, the second heat plate may be in the form of a cap that covers one end of the sensor housing.

In some embodiments the second heat plate comprises a cap having an opening covered by a metal gauze, through which metal gauze gas to be detected may pass into a space enclosed by said sensor housing, the arrangement being such that, in use, said metal gauze may be warmed or cooled via thermal contact with said at least one heat pipe. In this way freezing of water or build up of ice or snow around the sensor is inhibited.

In other embodiments said at least one heat pipe is in direct thermal contact with a sensor housing located externally of said detector. This may be the case when the at least one heat pipe is ‘designed into’ a detector before manufacture and therefore an intermediate heat plate or cap is not needed for heat transfer purposes.

In certain aspects the at least one heat pipe is in direct thermal contact with a firewall part of said sensor housing, which firewall part is permeable to permit passage of gas to be detected into an internal space enclosed by said sensor housing. For example, the at least one heat pipe may be in direct thermal contact with a sintered disc covering an opening in the sensor housing, through which disc and opening gas to be detected may pass. In this way blocking of the opening by ice or snow can be inhibited.

According to some other aspects of the invention there is provided for use in a detector, such as a gas, smoke or flame detector, a heating or cooling apparatus comprising at least one temperature sensor, a heating and/or cooling element and at least one heat pipe for connection between a first and a second part of the detector, the arrangement being such that, in use, said temperature sensor provides an output signal indicating a temperature of a part of said at least one heat pipe, and which output signal is used to control said heating and/or cooling element to warm or cool said at least one heat pipe. As such, a heating apparatus can be manufactured and sold (perhaps in kit form) that is suitable for retrofitting to existing detectors.

In yet other aspects of the invention there is provided a method of adapting a detector, such as a gas or flame detector, which method comprises the step of installing a heating apparatus as set out above into said detector.

According to another aspect of the invention, there is provided a method of surveying an area for emission of flame, smoke or gas, which method comprises the step of installing in or adjacent to said area one or more detector as set out above. In certain aspects the area under surveillance may be an Ex arca.

### BRIEF DESCRIPTION OF THE FIGURES

For a better understanding of the present invention reference will now be made, by way of example only, to the accompanying drawings in which:

FIG. 1 is a schematic cross section through a heat pipe to show the principle of operation;

FIG. 2 is a schematic perspective view of a heating and/or cooling assembly according to the present invention;

FIG. 3 is a schematic side cross section view of the heating assembly of FIG. 2;

FIG. 4 is a schematic perspective view of a detector comprising the heating assembly of FIG. 2; and

FIG. 5 is schematic side cross section view of the detector of FIG. 4.

### DETAILED DESCRIPTION OF THE PREFERRED EMBODIMENTS

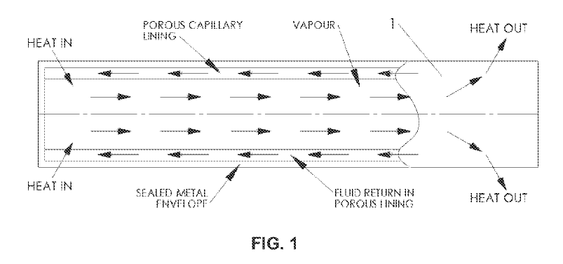

Referring to FIG. 1 a heat pipe 1 comprises a cylindrical pipe sealed at both ends. The pipe comprises a material of high thermal conductivity, such as copper or aluminium. During manufacture air is removed from the inside of the pipe (e.g. using a vacuum pump) and the pipe is filled with a fraction of a percent by volume of a working fluid suitable for the operating temperature, and then the ends sealed. It is to be noted that use of a vacuum is not essential: the working fluid is boiled in the heat pipe until the resulting vapour has purged the non condensing gases from the pipe and then the open end is sealed. Examples of working fluid include, but are not limited to: water, ethanol, acetone, sodium or mercury. The partial vacuum inside the pipe that is near or below the vapour pressure of the working fluid ensures that some of the fluid will be in the liquid phase and some will be in the gas phase. By using a vacuum during manufacture, the working gas does not need to diffuse through any other gas inside the pipe during use, and so the bulk transfer of the vapour from the warmer end to the cooler end of the heat pipe is at the speed of the moving molecules.

The pipe may optionally comprise a wick structure or porous capillary lining The function of the wick is to exert a capillary pressure on the liquid phase of the working fluid. The wick is typically a sintered metal powder or a series of grooves parallel to the pipe axis, but it may be anything capable of exerting capillary pressure on the condensed liquid to wick it back to the warmer end. The heat pipe may not need a wick structure if gravity or some other source of acceleration is sufficient to overcome surface tension and cause the condensed liquid to flow back to the warmer end.

In use, the vapour pressure over the warmer (liquid) working fluid at the warmer end of the pipe is higher than the equilibrium vapour pressure over condensing working fluid at the cooler end of the pipe, and this pressure difference drives a rapid mass transfer of vapour to the condensing end where the excess vapour condenses, releases its latent heat, and warms the cooler end of the pipe. The condensed working fluid then flows back to the warmer end of the pipe. If the heat pipe is vertically-oriented, the working fluid may be moved back to the warmer end by the force of gravity. If the heat pipe comprises a wick, the working fluid is returned by capillary action. Such heat pipes are available commercially, for example from CRS Engineering (www.heat-pipes.co.uk).

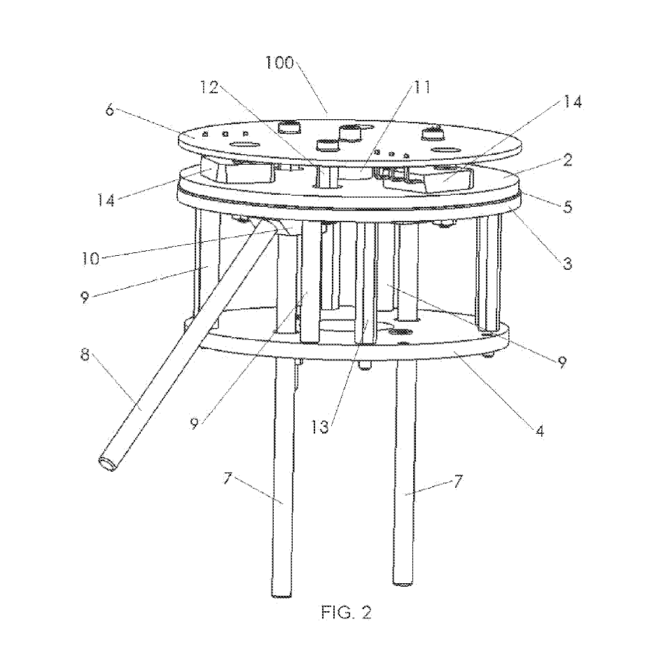

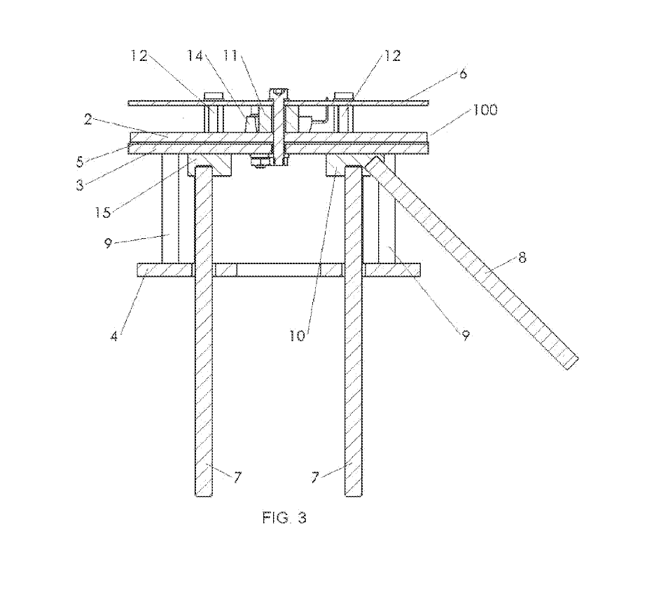

Referring to FIGS. 2 and 3 a heating assembly generally identified by reference numeral 100 is designed to be fitted (either retro-fit or a point of manufacture) into a chemical detector, or other gas or flame detector. Although this embodiment is described as a heating assembly, it is to be noted that the principle of the invention can be adapted to provide a cooling assembly, and a heating and/or cooling assembly.

The heating assembly 100 comprises a cylindrical heating element plate 2 of 90 mm diameter by 3 mm thickness, and which is made from aluminium (any other material with a high conductivity can be used e.g. copper). The heating clement plate 2 could by other dimensions and shapes to suit the particular application. Connecting pillars 12 (made from nickel plated brass) hold a heat pipe plate 3 (which in this embodiment is of the same material and dimensions as the heating element plate 2, although this is not essential) against the heating clement plate 2, the two plates separated by electrically insulating material 5. The electrically insulating material 5 comprises KAPTON® MT which is a thermally conductive, but electrically insulating, polyimide film; the material 5 has a thermal conductivity of 0.37 W/mK and is 25 μm thick. Ideally the insulating material 5 is as thin as possible, but we have found that the limiting factor is the ability to handle the material and drill holes through it. The mentioned thickness has been found to be workable. Collars around the connecting pillars 11 and a conductive block 11 serve to space a PCB 6 above the heating element plate 2. The heating element plate 2 is thermally connected to a control PCB 6 by the conductive block 11 (made from a soft grade of aluminium for increased thermal conduction properties). Heating elements 14 are mounted on the upper exposed surface of the heating element plate 2; in this embodiment, the heating elements comprise three power transistors (TOSHIBA® K3845) spaced around the upper surface of heating element plate 2, and which output a total of 80 W at 15V in use. The power transistors are directly connected via their positive sides to the heating element plate 2. This orientation improves conduction and ensures that heat is passed from the power transistors to the heating element plate 2 as efficiently as possible. The electrically insulating material 5 insulates the heating element plate 2 from the heat pipe plate 3 for safety; as mentioned above the insulating material has good thermal conduction properties to ensure efficient heat transfer between the two plates. The heating element plate 2, insulating material 5 and the heat-pipe plate 3 are physically as large as possible (within the confines of the detector in which the heating assembly 100 is to be used) to aid control of the ambient temperature of the enclosure. In use, the control PCB 6 monitors the temperature of the heating element plate 2 via the conductive block 11, and supplies power to the heating elements 14 as described in greater detail below.

During the design stage of the heating apparatus 100, the total amount of power needed to heat the detector must be approximately determined, having regard to factors including: the position of the detector, the intended working environment, the desired temperature inside the detector and major areas of heat loss from the detector. For example, in this particular embodiment, the power required was determined to be about 53 W. Allowing a safety margin of 1.5 times this value gives a required power of 80 W. Other safety margins such as two or three times the required power could be used. The heating elements are then chosen to provide this required maximum power. The importance of designing the heating apparatus 100 in this way will be described in greater detail below.

The number of heating elements 14 is selected so that in use the heating element plate 2 is warmed (or cooled) substantially evenly i.e. so that is has an even temperature across its surface and there are no cold (or warm) spots. We have found that the number of heating elements needed is a function of the thickness of the heating element plate 2: more heating elements are required for a thinner plate, whereas a thicker plate requires fewer heating elements.

It is not essential to use power transistors; resistors or other heating device(s) could be used instead. In the latter case either the heating element plate 2 or the heat pipe plate 3 and the insulating material 5 are not necessary since resistors would not cause the heating element plate to become electrically charged.

A lower heating plate 4 (having the same dimensions and material as the heat pipe plate 3) is spaced from the heat pipe plate 3 by four connecting pillars 13 (see FIG. 3). Heat pipes 9 of 5 mm diameter are mounted between the heat pipe plate 3 and lower heating plate 4. The ends of the four heat pipes 9 are spaced around the lower heat pipe plate and heat pipe plate 3 to provide good heat distribution.

Heat pipe connection blocks 10 (made from aluminium), are mounted on the lower exposed surface of the heat pipe plate 3. Alternatively if the heat pipe plate 3 is thick enough, it is possible to insert the heat pipes into a recess in the plate instead; we have found that a depth of 3 mm gives sufficient surface contact for good heat transfer. Two straight heat pipes 7 are mounted substantially perpendicular to heat pipe plate 3 on the connection blocks 10 and pass through bores in the lower heating plate 4. The heat pipes 7 comprise tin-coated copper pipes containing water as the working fluid, and are of 5 mm diameter and 100 mm length. A straight heat pipe 8, having the same dimensions and construction as the heat pipes 7, is mounted on a connection block 10 to form an angle of 45 degrees with the heat pipe plate 3.

Where an end of a heat pipe 7, 8 or 9 is connected to a heat plate via a heat pipe connection block 10, it is thermally connected using thermally conductive grease to ensure bond and good heat transfer during use.

The working fluid in the heat pipes is selected to have a lower working temperature (i.e. at least some of the fluid is in the liquid phase) than the lowest operating temperature of the detector in which it is mounted. For example it might be desirable to have a detector rated to work down to −50° C. In that case the working fluid is chosen so that, at the pressure within the heat pipe, the freezing point of the fluid is not greater than −50° C. This ensures that over the operating temperature range of the detector (e.g. −50° C. to +85° C.) there is always vapour available for evaporation and then condensation within the heat pipe.

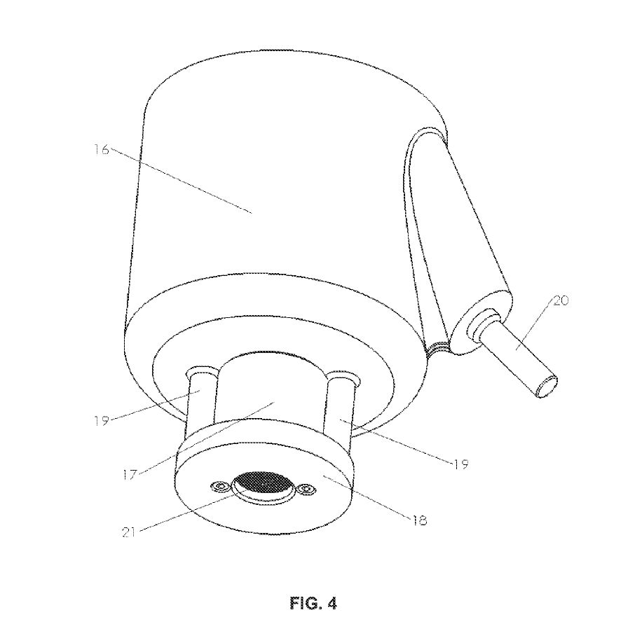

FIG. 4 shows a detector comprising a heating assembly 100 as described above. In this embodiment, the detector is a chemical detector, although the heating assembly can be used in any gas, smoke or flame detector. The detector comprises a housing or enclosure 16 made from aluminium (or stainless steel) and the detector has overall dimensions of about 115 mm in height and 100 mm in diameter, and weighs about 1.5 kg. It is rated to the IEC Ex standard and thus is suitable for use in explosive atmospheres. In use the detector can be mounted on a pole or wall in an industrial environment to be monitored for a gas leak (e.g. flammable and toxic gas). The enclosure 16 has a main body part which houses the majority of the heating assembly 100 and other components of the detector.

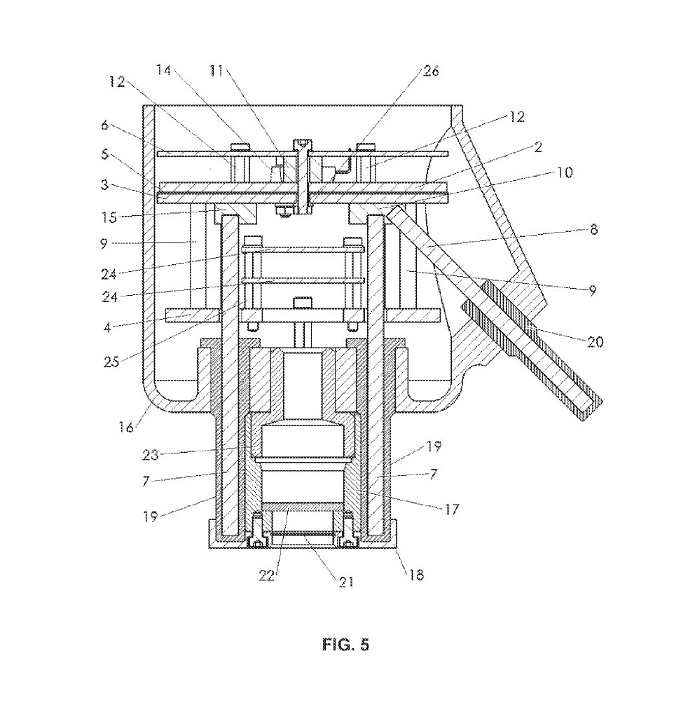

Referring to FIG. 5 the detector also comprises a chemical cell gas sensor housing 17 (also made from aluminium or stainless steel); the enclosure 16 acts as a junction box for receiving the gas sensor housing (e.g. by screw thread) and for supplying power to the sensor. The gas sensor housing may be any type presently available (or any future type); in this embodiment the gas sensor is a GD210 series housing as manufactured by Grovelcy Detection Limited. The housing is suitable for holding a wide range of chemical sensors such as catalytic bead sensors (or any other pellistor or electrochemical sensor). The gas sensor housing 17 further comprises a sintered disc 22 whose function is to provide a firewall (enabling the detector to receive the appropriate certification), but at the same time to permit gas to migrate into the housing to reach a sensor mounted therein.

The gas sensor housing 17 has an operating range of 31 20° C. to 40° C. and must enable gas outside the sintered disc 22 to migrate therethrough in almost any conditions within the operating range. If the environment external to the detector has dropped below freezing point, the sintered disc 22 and/or area just outside is liable to become blocked by ice. Furthermore, typical gas sensors mounted in the gas sensor housing 17 comprise simple electronics: for example pellistor-type sensors have wires that are highly temperature dependant near the upper end of the operating range (e.g. 40° C.) so it is desirable to maintain temperature around the whole sensor within the working range if possible.

During manufacture, a gas sensor would be wired into an interface circuit 24 which will convert a mV signal from the sensor (indicating presence of a gas to be detected) into a logic that is understood by the control PCB 6. This arrangement works relatively well but cannot indicate temperature at the sintered disc 22 and therefore there is no inbuilt fail-safe function to indicate potential loss of sensitivity in the gas sensor due to environmental changes, such as freezing conditions.

A detector heat plate (or cap) 18 comprises a solid annular disc made from aluminium and of 58 mm diameter and 9 mm depth, and is mounted onto the gas sensor housing by screws. The detector heat plate 18 comprises two recesses for receiving the ends of each of the heat pipes 7 respectively. The heat plate 18 comprises an opening at its centre covered by a metal gauze 21 made from aluminium, and which has slightly bigger pore size (250 μm) than the sinter (123 μm) so that particulates not blocked, and through which air (including any gas to be detected) and moisture can pass. Other pore sizes are possible. The metal gauze 21 is in thermal contact with the detector heat plate 18. It is to be noted that, in this embodiment, the heating assembly has been retrofitted to the detector; it is therefore necessary for the heat pipes 7, detector heat plate 18 and the metal gauze 21 to be fitted around the existing gas sensor housing 17. In other embodiments, for example where a new detector is being designed with the heat assembly incorporated, it is possible for the ends of the heat pipes 7 to be in contact with the sintered disc 22, rendering the detector heat plate 18 and metal gauze 21 unnecessary in that case.

During manufacture the control PCB 6 is set to maintain the temperature of the heating element plate 2 at a pre-determined value, 5° C. for instance. The detector interface circuit 24 is then connected to the control PCB 6 so that no additional connections are required from the customer. The control PCB 6 can then supply a fail-safe temperature signal in addition to the sensor signal to alert if the detector is outside of working parameters.

In use, the heating elements 14 heat the heating element plate 2 under control of the control PCB 6 according to the temperature indicated by a temperature sensor on the control PCB 6 that is in thermal contact with the temperature sensor conductor 11. The control PCB switches power on and off to maintain the heating clement plate 2 at the preset temperature value. Via the heat pipe plate 3 and heat pipes 7, 8, 9 heat is transferred to different parts of the detector such as the gas sensor housing 17. Due to the nature of heat-pipe operation the temperature at both ends of each heat pipe will be virtually identical (e.g. within 0.5° C.). Accordingly the temperature of the heating plates at each end of the heat pipes will be approximately the same.

In particular the heat pipes 7, 8, 9 efficiently move heat from the heat pipe plate 3 to other heat plates in different areas of the detector. For example lower heating plate 4 works in conjunction with the heating element plate 2 and heat pipe plate 3 to heat the internal space within the enclosure 16 around the internal electronic components. Detector heat plate 18 supplies heat to the metal gauze 21; in this way the chance of freezing is greatly reduced and allows gas to enter the sensor over an extended lower temperature range. As explained above, to allow correct operation of the sensor the metal gauze 21 should have a pore size larger than the sinter. Heat is transferred across the ingress/explosive wall of the enclosure 16 using aluminium heat pipe covers 19 which maintain integrity whilst permitting the heat pipes 7 to transport heat from within the enclosure 16 to a point adjacent the gas sensor housing 17.

As described above, in this example the heating elements 14 have a maximum power output of 80 W. This is more than the detector is ever likely to need, assuming a worst case scenario. Accordingly, however the heat loss varies from the heat pipes 7, 8, 9 and heat plates due to external environmental conditions, the heating elements are able to provide enough power to maintain the heating element plate 2 and heat plates 7, 8, 9 at or very near to the desired temperature. However, care does need to be taken to ensure that the rate of heat transfer does not exceed the maximum rated heat transfer capacity of the heat pipes. To do this, heat pipes are specified with a greater transfer capacity than system power. This is done to ensure that the heat pipes arc not overloaded in the worst case scenario, for example if other heat pipes become detached or a specific area of the detector is exposed to an extreme temperature or wind chill. In this embodiment the maximum capacity of each heat pipe is 85 W, and the maximum system power is 80 W.

All of the heat pipes 7, 8, 9 are connected to a single heat plate (in this embodiment comprising the clement heating plate 2 and heat pipe plate 3). In this way the temperature of certain parts of the detector can be controlled using a single temperature sensor. Whatever the rate of heat loss at the ends of the heat pipes 7, 8, 9, the heating elements 14 supply heat at a rate sufficient to maintain the single heat plate at the desired temperature, thereby keeping components adjacent the ends of the heat pipes at substantially the same temperature without the need for individual monitoring of temperatures at points around the detector. In this way efficient use of heating/cooling power is made based on a set temperature to control the temperature of different areas of a detector.

One particular advantage of certain embodiments of the invention is that detector ingress/explosive ratings are preserved. Furthermore in some embodiments the power source is contained inside the main enclosure 16, avoiding the disadvantage of detectors with heating elements outside the main enclosure: in such detectors, excess heat can build up which is very dangerous in explosive atmospheres.

Heat pipe 8 can be used to cool the detector. The integrity of the enclosure 16 is maintained using an aluminium heat pipe cover 20 which enables connection to a heat-sink or cooling device (for example: a compressed air feed switched on and off using a solenoid valve; pipe for circulating a refrigerant over the surface of the heating element plate 2; or peltier heating/cooling device) outside of the high ambient temperature zone. It is to be noted that the heat pipe 8 would not normally be fitted to the detector if it were to be used exclusively in a cold environment. Similarly, when the detector is to be used in a warm environment, it may be fitted only with one or more cooling heat pipe like the heat pipe 8. To that end the heating clement plate 2 may be cooled by one or more cooling device which maintains the heating element plate at a temperature lower than that of the ambient environment.

In another embodiment, the heating element plate 2 may be provided both with heating and cooling devices, and the PCB controller programmed to select either heating or cooling according to the temperature indicated by the temperature sensor on the PCB 6.

The concepts embodied by the heating assembly 100 described herein, and its various alternatives, may be used to design other similar heating assemblies for retrofit to any existing detector. Alternatively, the same concepts may be used to incorporate the heating assembly 100 into a new detector. In other embodiments the heating assembly may be a stand-alone device that can be attached externally to a detector for example.

Examples of areas in which the detectors described herein may used to detect gas, smoke or flame include, but are not limited to: automotive refuelling stations or petrol stations; oil refineries, rigs and processing plants; chemical processing plants;

printing industries and textiles; hospital operating theatres (e.g. detecting oxygen or other gas leaks); aircraft refuelling and hangars; surface coating industries; sewerage treatment plants; and gas pipelines and distribution centres.

1. A detector, such as a gas, smoke or flame detector, having a housing which provides protection against explosion and/or ingress, which detector comprises at least one temperature sensor, a heating and/or cooling element and at least one heat pipe connected between a first and a second part of the detector, the arrangement being such that, in use, said temperature sensor provides an output signal indicating a temperature of a part of said at least one heat pipe, and which output signal is used to control said heating and/or cooling element to warm or cool said at least one heat pipe, whereby the temperature at each of said first and second parts of the detector may be maintained substantially the same.

2. The detector of A detector as claimed in claim 1, further comprising a heating element plate or member in thermal contact with said at least one heat pipe, the arrangement being such that, in use, the temperature of said heating element plate is monitored by said temperature sensor and said heating element plate is heated or cooled by said heating and/or cooling element to control the temperature of said at least one heat pipe.

3. The detector of claim 2, wherein said temperature sensor is single temperature sensor arranged to monitor the temperature of said heating element plate, whereby the temperature of multiple parts of said detector may be controlled using said single temperature sensor.

4. The detector of claim 2, further comprising a plurality of heat pipes and wherein said heating element plate is in thermal contact with at least two of said plurality of heat pipes.

5. The detector of claim 1, wherein said housing comprises a main body holding the majority of the components of the detector, and wherein said first part of the detector is within said main body and said second part of the detector is external of said main body.

6. The detector of claim 1, further comprising a first heat plate mounted within said detector and in thermal contact with said at least one heat pipe, wherein in use, said first heat plate is warmed or cooled by said at least one heat pipe such that said first heat plate warms or cools an internal space within said detector.

7. The detector of claim 1, further comprising a second heat plate in thermal contact with said at least one heat pipe, which second heat plate is remote from said heating and/or cooling element.

8. The detector of claim 7, wherein said second heat plate is in thermal contact with a sensor housing on an external surface of said detector.

9. The detector of claim 8, wherein said second heat plate comprises a cap having an opening covered by a metal gauze, through which metal gauze gas to be detected may pass into a space enclosed by said sensor housing, the arrangement being such that, in use, said metal gauze may be warmed or cooled via thermal contact with said at least one heat pipe.

10. The detector of claim 1, wherein said at least one heat pipe is in direct thermal contact with a sensor housing located externally of said detector.

11. The detector of claim 10, wherein said at least one heat pipe is in direct thermal contact with a firewall part of said sensor housing, which firewall part is permeable to permit passage of gas to be detected into an internal space enclosed by said sensor housing.

12. The detector of claim 1, wherein said detector provides ingress and/or explosion protection to a national or international standard such as IEC Ex or EN 60079-0.

13. For use in a detector, such as a gas, smoke or flame detector, having a housing which provides protection against explosion and/or ingress, a heating or cooling apparatus comprising at least one temperature sensor, a heating and/or cooling element and at least one heat pipe for connection between a first and a second part of the detector, the arrangement being such that, in use, said temperature sensor provides an output signal indicating a temperature of a part of said at least one heat pipe, and which output signal is used to control said heating and/or cooling element to warm or cool said at least one heat pipe.

14. A method of adapting a detector, such as a gas or flame detector, having a housing which provides protection against explosion and/or ingress, which method comprises the step of installing into said detector a heating or cooling apparatus comprising at least one temperature sensor, a heating and/or cooling element and at least one heat pipe for connection between a first and a second part of the detector, the arrangement being such that, in use, said temperature sensor provides an output signal indicating a temperature of a part of said at least one heat pipe, and which output signal is used to control said heating and/or cooling element to warm or cool said at least one heat pipe.

15. A method of surveying an area for emission of flame, smoke or gas, which method comprises the step of installing in or adjacent to said area one or more detector having a housing which provides protection against explosion and/or ingress, which detector comprises at least one temperature sensor, a heating and/or cooling element and at least one heat pipe connected between a first and a second part of the detector, the arrangement being such that, in use, said temperature sensor provides an output signal indicating a temperature of a part of said at least one heat pipe, and which output signal is used to control said heating and/or cooling element to warm or cool said at least one heat pipe, whereby the temperature at each of said first and second parts of the detector may be maintained substantially the same.
